(19) United States
(12) Patent Application Publication
(10) Pub. No.: US 2010/0095669 A1
(43) Pub. Date: Apr. 22, 2010

(54) Wax Actuator and a Method of Actuating by Means of a Wax Actuator

(75) Inventors: Philip Wayne Loveday, Halfway House (ZA); Craig Stephen Long, Silverton (ZA)

Correspondence Address: THE H.T. THAN LAW GROUP, WATERFRONT CENTER SUITE 560, 1010 WISCONSIN AVENUE NW, WASHINGTON, DC, 20007, US

(73) Assignee: CSIR, Pretoria (ZA)

(21) Appl. No.: 12/531,588

(22) PCT Filed: Mar. 14, 2008
(86) PCT No.: PCT/IB08/50958

§ 371 Date: Sep. 16, 2009

(30) Foreign Application Priority Data
Mar. 16, 2007 (ZA) 2007/02217

(51) Int. Cl. F03G 7/06; F15B 21/06

(52) U.S. Cl. 60/527

(57) ABSTRACT

The invention relates to a method of actuating by means of a wax actuator and to a wax actuator. The wax actuator (10, 100, 200) includes a wax expansion generator comprising a housing (12) defining a chamber (18) which is partially filled with wax (20.1) and partially filled with hydraulic fluid, the wax (20.1) and the hydraulic fluid being separated by at least one sealing interface (20.2, 202), and heating means (22) for heating the wax (20.1) to cause it to melt and expand. The wax actuator (10, 100, 200) further includes a hydraulic transmission device comprising a hydraulic line (38) in communication with the hydraulic fluid within the chamber (18) and a connector (40) at a downstream end of the hydraulic line (38) for use in connecting the hydraulic line (38) to a working object.

THIS INVENTION relates to actuating by means of wax actuators. It relates more specifically to a method of actuating by means of a wax actuator and to a wax actuator.

A typical wax actuator, or paraffin wax actuator, also known as a wax linear motor, or as a paraffin wax linear motor, comprises a rigid housing defining a partially enclosed internal volume or chamber filled with wax, and an output shaft sealingly translatable into and out of the internal volume and being exposed to the wax within the internal volume. When the wax is heated, it undergoes a large expansion on melting. The expansion is transmitted to the output shaft to produce actuation force and displacement. In one kind of embodiment, available heat is used to heat the wax. In another kind of embodiment, an internal heating element is used to heat the wax. Waxes or combinations thereof are selected to provide desired temperature/expansion characteristics.

The use of waxes, specifically paraffin waxes, is common, but it is possible to use waxes other than paraffin waxes. This invention is not limited to the use of a specific kind of wax, and references to “paraffin wax” must be read as referring also to a wax other than a paraffin wax if the context so allows. References to “wax” must be interpreted as including a paraffin wax if the context so allows.

In accordance with one aspect of the invention, there is provided a method of actuating by means of a wax actuator, the method including:

transferring mechanical energy, as a result of expansion of wax on melting in the wax actuator, to a hydraulic fluid via a sealing interface;

transferring the mechanical energy via the hydraulic fluid along a hydraulic line to a working object at a desired location; and

actuating the working object by transferring the mechanical energy thereto.

The method may include conducting, at the desired location, the hydraulic fluid into a pressure chamber and subjecting a plunger over a pre-selected effective area to the pressure chamber. The plunger may then be displaced with force, which can be used for the actuating.

By way of development, the method may be carried out intermittently, in successive steps and may then include:

containing, at the end of expansion of the wax, the hydraulic fluid by means of a non-return valve downstream of the wax;

contracting the wax by cooling and charging the hydraulic fluid afresh between the sealing interface and the non-return valve; and

heating the wax to initiate a successive step.

Further, the wax may comprise a plurality of different waxes respectively having different melting points and/or expansion characteristics, thereby to achieve successive stages of or staggered expansion of the wax.

The invention extends to a wax actuator including:

a wax expansion generator comprising:

a housing defining a chamber which is partially filled with wax and partially filled with hydraulic fluid, the wax and the hydraulic fluid being separated by at least one sealing interface; and

heating means for heating the wax to cause it to melt and expand; and

a hydraulic transmission device comprising:

a hydraulic line in communication with the hydraulic fluid within the chamber; and

a connector at a downstream end of the hydraulic line for use in connecting the hydraulic line to a working object.

The sealing interface may be in the form of a membrane. Instead, it may be in the form of a plunger displaceable in a cylinder.

By way of development, the wax actuator may include, in the hydraulic line, or toward a downstream end of the chamber:

a non-return valve arranged to allow hydraulic fluid to flow from the chamber along the hydraulic line, and to prevent return flow; and

a hydraulic fluid charging device for charging hydraulic fluid afresh into the chamber upstream of the non-return valve.

By way of further development, more than one hydraulic line may be in communication with the chamber to serve correspondingly more than one output.

In a preferred embodiment, the wax may be provided in modules or pellets having respective sealing enclosures. The sealing enclosures may then provide the sealing interface. The sealing enclosures may be in the form of silicone rubber capsules.

The wax actuator may include at least two different waxes in different modules or pellets, each wax having its own particular melting point and/or other expansion characteristics, thereby to achieve successive stages of or staggered expansion of the modules or pellets.

The invention is now described by way of example with reference to the accompanying diagrammatic drawings.

In the drawings:

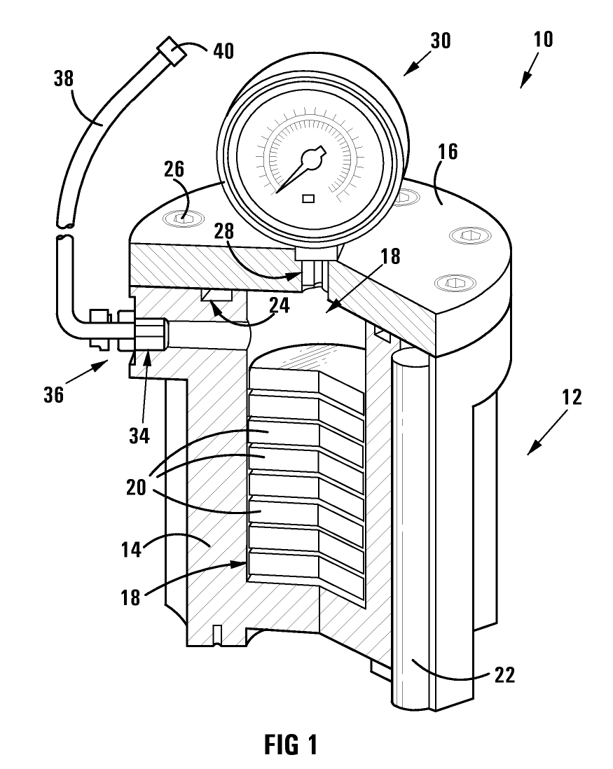

FIG. 1 shows, in a partly cut-away view, an embodiment of a wax actuator, in accordance with the invention;

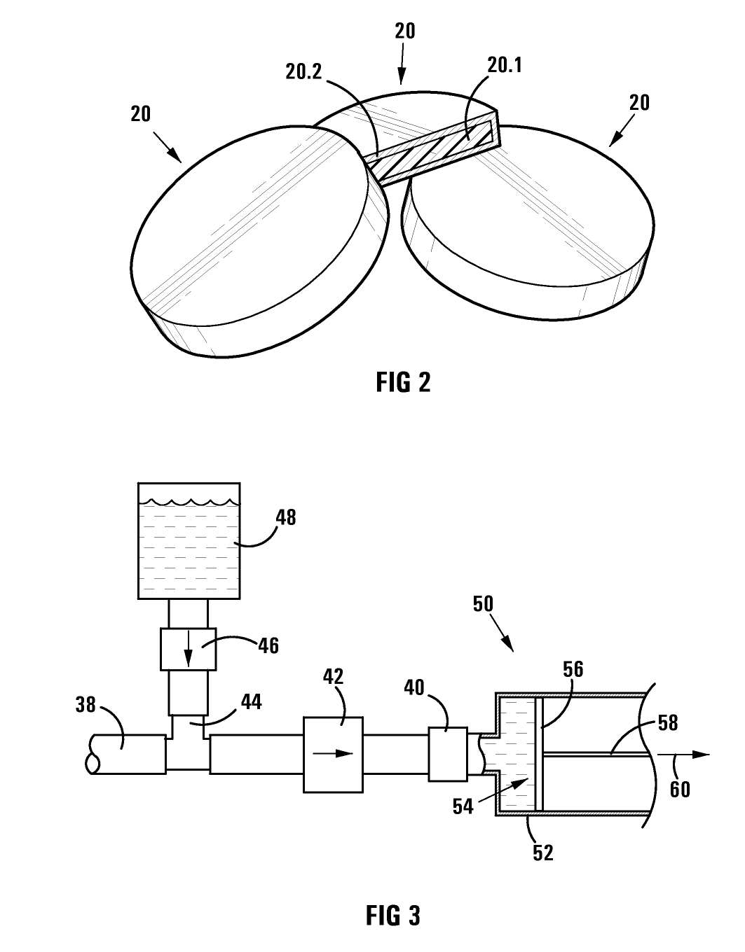

FIG. 2 shows, to a larger scale, a few wax capsules, one of them being sectioned to show its internal structure;

FIG. 3 shows an applicator for transferring mechanical energy from the wax actuator of FIG. 1 to a working object;

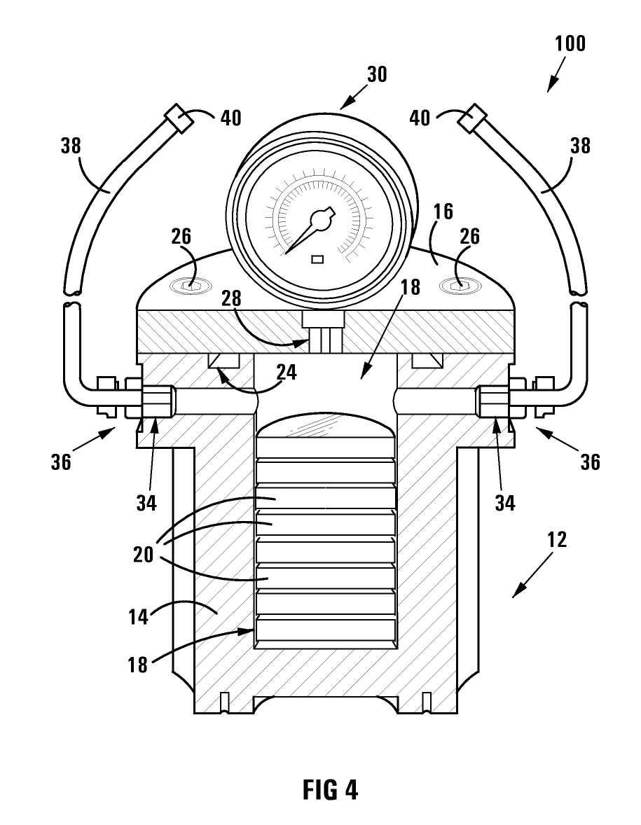

FIG. 4 shows an alternative embodiment of a wax actuator, in accordance with the invention; and

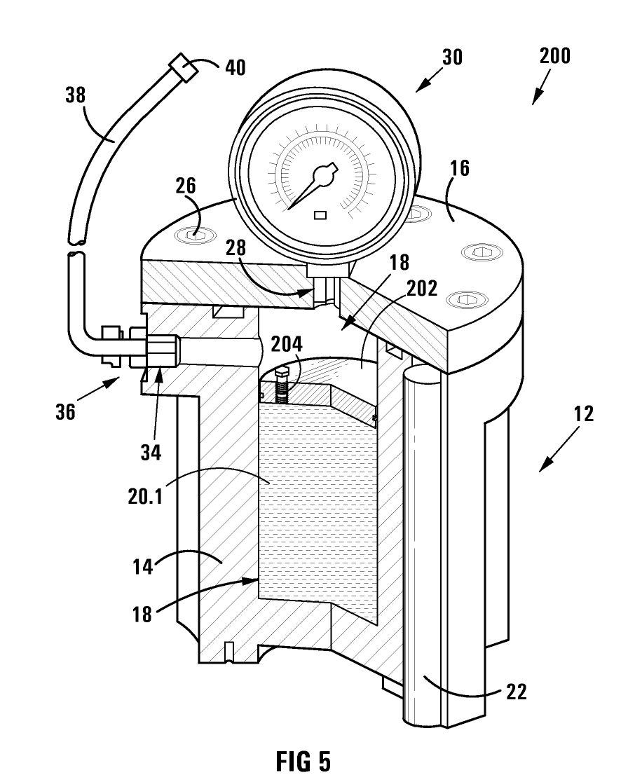

FIG. 5 shows another alternative embodiment of a wax actuator, in accordance with the invention.

With reference to FIG. 1 of the drawings, a wax actuator in accordance with the invention is generally indicated by reference numeral 10.

The wax actuator 10 includes a wax expansion generator comprising a housing 12, a body 14 and a removable and sealable cover 16.

The body 14 comprises an internal chamber 18. The chamber 18 is of round cylindrical form in this embodiment.

Within the chamber 18, there are provided a plurality of wax capsules in disc form in stacked relationship, each generally indicated by reference numeral 20. With reference to FIG. 2, each capsule 20 comprises a core of wax indicated by reference numeral 20.1, surrounded by a sealing enclosure 20.2 which, in this embodiment, is of silicone rubber. The sealing enclosure 20.2 acts as a sealing interface between the core of wax 20.1 and hydraulic fluid.

The wax capsules 20 fill most of the chamber 18, but leave a space at the top to accommodate hydraulic fluid. It is to be appreciated that the hydraulic fluid will migrate into the rest of the chamber 18 and will fill up any spaces intermediate the wax capsules 20.

The chamber 18 has an outlet which is generally indicated by reference numeral 34 and in which a connector 36 is provided. The connector 36 connects the chamber 18 with a hydraulic transmission device in the form of a hydraulic line 38 having a connector 40 at a free, downstream end thereof.

The cover 16 is sealingly placeable on the body 14, sealing being by means of a sealing ring in a sealing groove 24 in a top of the body 14, and circumferentially spaced capscrews 26 screwing the cover 16 down onto the body 14.

A central aperture 28 through the cover 16 leads to a pressure gauge 30 screwingly secured in the aperture 28.

The body 14 includes auxiliary chambers housing a plurality of heating elements 22. The auxiliary chambers are upwardly open to be accessible when the cover 16 has been removed to insert or replace heating elements 22. The cover 16 seals the open ends of the auxiliary chambers.

The heating elements 22 are placed in the auxiliary chambers. The heating elements 22 may, conveniently, be electrically powered.

Referring now also to FIG. 3, reference numeral 50 generally indicates an applicator for transferring the mechanical energy via the hydraulic fluid along the hydraulic line 38 to a working object (not illustrated) at a desired location. The applicator 50 includes a barrel 52 defining a round cylindrical pressure chamber 54 therein. A plunger 56 is linearly displaceable in a direction indicated by arrow 60 within the chamber 54 and a connecting rod 58 is coupled to the working object thereby to transfer the mechanical energy to, and actuate, the working object. An effective area of the plunger 56 can be pre-selected to configure or control the transfer of mechanical energy, and hence actuation characteristics.

In use, the cover 16 is sealingly replaced and the chamber 18 is charged with hydraulic fluid. Charging may be via the outlet 34 with the connector 36 temporarily removed. If so, it is replaced together with the hydraulic line 38. The connector 40 is appropriately connected to the applicator 50, and the hydraulic line 38 is primed. Preferably, a dedicated bleeding outlet valve (not illustrated) may be provided to facilitate priming.

The heating elements 22 are heated to melt and expand the wax within the capsules 20. Such expansion transfers mechanical energy across the sealing enclosure 20.2 to the hydraulic fluid thereby pressurising the hydraulic fluid in the chamber 18 which, in turn, causes the hydraulic fluid to flow under pressure and transfer the mechanical energy via the hydraulic line 38, the connector 40, and the applicator 50 to the working object to perform actuation.

By way of development, and referring specifically to FIG. 3, a non-return valve 42 can be provided, for example in the hydraulic line 38, which allows flow only out of the chamber 18. Alternatively, a non-return valve could be provided in the outlet 34, the connector 36 then being immediately downstream of the non-return valve. A separate charging line 44 into the hydraulic line 38 or chamber 18 may be provided, also in conjunction with a non-return valve 46 which allows flow only into the hydraulic line 38 or the chamber 18. Then, when the heating elements 22 have been used to expand the wax capsules 20, and hydraulic fluid has been expelled from the chamber 18 via the hydraulic line 38 to the applicator 50, the wax capsules are allowed to cool down and contract while fresh hydraulic fluid is charged, e.g. from a hydraulic fluid reservoir 48, into the hydraulic line 38 and/or the chamber 18. The initially expelled hydraulic fluid is prevented from flowing back from the applicator 50 by the non-return valve 42. When a fresh charge of hydraulic fluid has been charged into the chamber 18, the heating elements 22 are again used to expand the wax capsules 20 to expel and to pump a successive charge of hydraulic fluid via the hydraulic line 38 to the working object. This cycle is repeated thus causing the wax actuator 10 to operate as an intermittent pump.

It is a very important advantage that the position of the housing 12 and the position at which actuating takes place can be remote, even widely remote, from each other. Thus, the housing 12 and related components can be large if desired and can easily be subjected to heat, whereas the applicator 50 can be small or compact and can be kept at a low or constant temperature. It is to be appreciated that the flow rate of hydraulic fluid through the hydraulic line 38 is relatively low and transmission of energy is thus very efficient, even over relatively long distances.

The mechanical energy transfer characteristics can very easily be modified merely by selecting an appropriate applicator 50, more specifically selecting application of pressure over a pre-selected effective area of the plunger 56, by still using the same housing 12 and associated components, and bearing in mind that one applicator can be replaced easily and quickly by another applicator having different characteristics.

It is regarded as an important advantage that wax capsules are provided which are sealed with high integrity, easily to be handled, stored and otherwise dealt with. It also has the advantage of providing modularity. Furthermore, the use of more, smaller—as opposed to one or fewer, larger—capsules, increases the surface area to volume ratio, promoting a quicker response time.

It is to be appreciated that the number of wax capsules 20 used can be adjusted to adjust the amount of expansion. Furthermore, the wax in the capsules can appropriately be selected to obtain desired temperature or temperature range/expansion characteristics. This is an option which can be used if the device is set up for a specific application.

By way of further development, a plurality of wax capsules 20 could be provided, each capsule 20 containing a different wax having different melting point and/or other expansion characteristics from the wax in the other capsules 20. In this fashion, successive stages of or staggered expansion of the wax can be achieved as each type of wax melts at its respective melting point.

As illustrated in FIG. 4, a wax actuator can be provided having more than one hydraulic line 38 connected to the chamber 18, to serve or actuate correspondingly more than one applicator 50 and/or working object.

An alternative version of a wax actuator 200 is illustrated in FIG. 5. Instead of using discrete wax capsules 20, the chamber 18 is simply filled with wax 20.1 and an annular plunger 202 acts as a sealing interface to separate the wax 20.1 from the hydraulic fluid. The plunger 202 preferably includes a bleeding arrangement (e.g. threaded, matched bore and screw 204) to release any trapped air from beneath the plunger 204.

It is an advantage that wax actuator in accordance with the invention can quickly and easily be released, i.e. actuation can quickly and easily be terminated by merely dumping the hydraulic fluid, i.e. releasing hydraulic pressure. This is not possible with conventional wax actuators.

It is also regarded as an important advantage that the wax actuator can be used as a pump pumping hydraulic fluid intermittently in cycles as described above.

1. A method of actuating by means of a wax actuator, the method including:
transferring mechanical energy, as a result of expansion of wax on melting in the wax actuator, to a hydraulic fluid via a sealing interface, wherein the wax comprises a plurality of different waxes respectively having different expansion characteristics, thereby to achieve successive stages of or staggered expansion of the wax;
transferring the mechanical energy via the hydraulic fluid along a hydraulic line to a working object at a desired location; and
actuating the working object by transferring the mechanical energy thereto.

2. A method as claimed in claim 1, which includes conducting, at the desired location, the hydraulic fluid into a pressure chamber and subjecting a plunger over a pre-selected effective area to the pressure chamber.

3. A method as claimed in claim 1, which is carried out intermittently, in successive steps and includes:
containing, at the end of expansion of the wax, the hydraulic fluid by means of a non-return valve downstream of the wax;
contracting the wax by cooling and charging hydraulic fluid afresh between the sealing interface and the non-return valve; and
heating the wax to initiate a successive step.

4. A wax actuator including:
a wax expansion generator comprising:
a housing defining a chamber which is partially filled with wax and partially filled with hydraulic fluid, the wax being provided in modules or pellets having respective sealing enclosures, the wax and the hydraulic fluid being separated by at least one sealing interface; and
heating means for heating the wax to cause it to melt and expand; and
a hydraulic transmission device comprising:
a hydraulic line in communication with the hydraulic fluid within the chamber; and
a connector at a downstream end of the hydraulic line for use in connecting the hydraulic line to a working object.

5. A wax actuator as claimed in claim 4, in which the at least one sealing interface is in the form of at least one membrane.

6. A wax actuator as claimed in claim 4, in which the sealing interface is in the form of a plunger displaceable in a cylinder.

7. A wax actuator as claimed in claim 4, which includes, in the hydraulic line, or toward a downstream end of the chamber:
a non-return valve arranged to allow hydraulic fluid to flow from the chamber along the hydraulic line, and to prevent return flow; and
a hydraulic fluid charging device for charging the hydraulic fluid afresh into the chamber upstream of the non-return valve.

8. A wax actuator as claimed in claim 4, in which more than one hydraulic line is in communication with the chamber to serve correspondingly more than one output.

9. A wax actuator as claimed in claim 4, in which the sealing enclosures provide the sealing interface.

10. A wax actuator as claimed in claim 4, in which the sealing enclosures are in the form of silicone rubber capsules.

11. A wax actuator as claimed in claim 4, which includes at least two different waxes in different modules or pellets, each wax having its own particular melting point, thereby to achieve successive stages of or staggered expansion of the modules or pellets.
